(19) United States
(12) Patent Application Publication
(10) Pub. No.: US 2015/0077255 A1
(43) Pub. Date: Mar. 19, 2015

(54) Invisible concealed weapon identification system

(71) Applicant: George Allen Pallotta, The Woodlands, TX (US)

(72) Inventor: George Allen Pallotta, The Woodlands, TX (US)

(73) Assignee: TPKIDSCO LP, The Woodlands, TX (US)

(21) Appl. No.: 14/029,183

(22) Filed: Sep. 17, 2013

(51) Int. Cl. G08B 3/10; G08B 21/18

(52) U.S. Cl. CPC G08B 3/10; G08B 21/18
USPC 340/572.1

(57) ABSTRACT

The invisible concealed weapon identification system and method implements a non-visible marking, locating, and tracking system for arms, weapons, and guns to be identified and tracked. The weapon marking is accomplished thru a radio frequency identification tag mounted under the handle or stock pad of the weapon. A radio frequency identification tag reader is mounted or hand operated at any entrance or gate of schools, work facility, or public gathering places. The radio frequency identification tag reader can be electronically tied into a local area network thru a computer. Additionally, the reader and network can be nationally linked thru a computer to such as “cloud” data base and information sharing system.

### FEDERALLY SPONSORED RESEARCH

N/A

### SEQUENCE LISTING OR PROGRAM

No

### BACKGROUND

1. Technical Field of Invention 705.26.9

This invention relates to a locating of an item and more particularly to such a locating of an item with identification, location, and tracking.

2. Background of the Invention

The United States of America is a country founded through a revolution conducted by a series of militia against an oppressive foreign power. One of the founding principles of the United States Constitution is the right to “bear arms”. This founding principle has been interrupted many different ways by many different people over the last 200+ years. During the passing of these 200+ years arms or weapons have changed significantly. However one interrupts the founding and/or present laws it is obvious that too many people are killed annually by arms or weapons. Different groups argue the purpose of owning guns and what they could or should be used for. Everyone agrees that powerful weapons in the hands of the wrong person results in terrible consequents to possibly many persons. An example of the present tracking laws available are contained in 18 U.S.C. ¶923 (i) etc. A brief overview follows.

### Firearms Verification Overview

Marking Requirements
Licensed Importer—18 U.S.C. §923(i) and 27 CFR §478.92, 26 U.S.C. §5842 and 27 CFR §479.102
1. Serial Number
   Must be conspicuously engraved, cast or stamped (impressed) on the firearm frame or receiver
   The serial number cannot duplicate the serial number appearing on any other firearm the importer previously imported
   For firearms imported after Jan. 30, 2002, the engraving, casting or stamping (impressing) of the serial number must be to a minimum depth of 0.003 inch and in a print size no smaller than 1/16 inch
2. Name of Manufacturer
   Must be conspicuously engraved, cast or stamped (impressed) on the firearm frame, receiver, barrel or slide
   For firearms imported after Jan. 30, 2002, the engraving, casting or stamping (impressing) of the serial number must be to a minimum depth of 0.003 inch
3. Country of Origin
   Must be conspicuously engraved, cast or stamped (impressed) on the firearm frame, receiver, barrel or slide
   For firearms imported after Jan. 30, 2002, the engraving, casting or stamping (impressing) of the country of origin must be to a minimum depth of 0.003 inch
4. Model Designation (if Assigned)
   Must be conspicuously engraved, cast or stamped (impressed) on the firearm frame, receiver, barrel or slide
   For firearms imported after Jan. 30, 2002, the engraving, casting or stamping (impressing) of the model designation must be to a minimum depth of 0.003 inch
5. Caliber or Gauge
   Must be conspicuously engraved, cast or stamped (impressed) on the firearm frame, receiver, barrel or slide
   For firearms imported after Jan. 30, 2002, the engraving, casting or stamping (impressing) of the caliber or gauge must be to a minimum depth of 0.003 inch
6. Name of Importer
   Must be conspicuously engraved, cast or stamped (impressed) on the firearm frame, receiver, barrel or slide
   For firearms imported after Jan. 30, 2002, the engraving, casting or stamping (impressing) of the importer's name must be to a minimum depth of 0.003 inch
7. City & State of the Importer
   Must be conspicuously engraved, cast or stamped (impressed) on the firearm frame, receiver, barrel or slide
   For firearms imported after Jan. 30, 2002, the engraving, casting or stamping (impressing) of the importer's city and state must be to a minimum depth of 0.003 inch

While the preceding requirement(s) offers some traceability of properly marked weapons this afford no identification of the weapon without direct contact to the weapon. Many schools and gathering places have implemented gun screening but these are limited, by-passable, and sometimes too late to be effective.

Gun associations (National Rifle Association) spend millions each year to assure no gun legislation by Congress is enacted that contains any gun control system or methods. Many weapon owners appreciate and even cherish the mechanical beauty of the device and additional markings to their weapons would be additional reasons to avoid further visible markings.
Schools and public gathering places are often used for mentally damaged individuals to take lives with automatic weapons.

### SUMMARY OF THE INVENTION

As long as arms or weapons are available there will be accidents and reckless killings. However, the present technology offers an opportunity to register, track, and identify weapons before they are brought into such as schools without any visible markings. The purpose of the invisible concealed weapon identification system is to implement a non-visible marking and tracking system and method that offers schools and other gathering places a warning alert that a weapon is approaching. In one embodiment a radio frequency identification tag is secured under the handle or stock pad of a weapon. A radio frequency identification tag reader can be installed or hand operated any entrance to a school, work facility, or gathering place or even at a front/rear gate to identify any so tagged weapon. In another embodiment the radio frequency identification reader is tied into a local area network and centralized monitoring can easily be accomplished. In another embodiment the radio frequency identification reader and/or the local area network are tied into a centralized database such as through “cloud” implementation data base and information sharing.

### BRIEF DESCRIPTION OF THE DRAWINGS

FIG. 1 shows a block diagram of the modules that comprise a typical invisible concealed weapon identification system.

FIG. 2 shows a typical physical embodiment of typical Radio Frequency Identification (RFID) Tag.

FIG. 3 displays the system operational flow of a typical invisible concealed weapon identification system.

FIG. 3.1 discloses the setup of a weapon with a typical identification Tag.

FIG. 3.2 discloses the typical setup of a tag reader.

FIG. 3.3 discloses the typical operation of a tag when being read by a tag reader.

FIG. 4 shows a typical invisible concealed weapon identification system data base.

FIG. 5 shows a typical operating scenario for an invisible concealed weapon identification system.

### DETAILED DESCRIPTION OF THE DRAWINGS

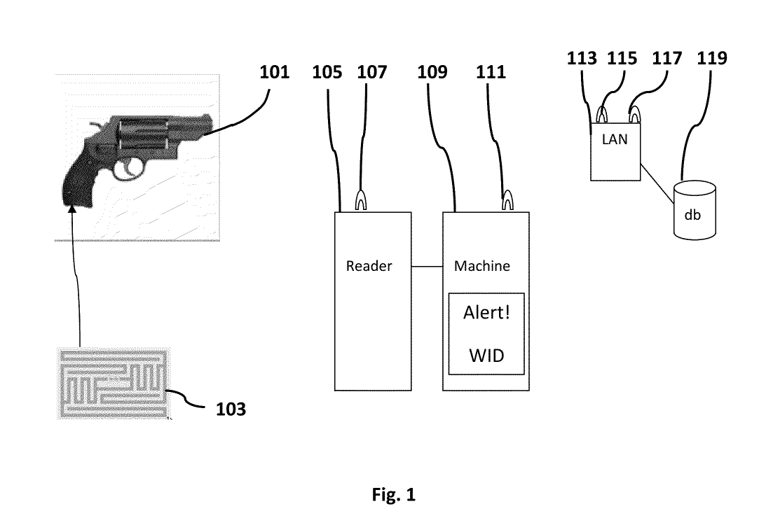

FIG. 1 shows a block diagram of the modules that comprise a typical invisible concealed weapon identification system. A weapon 101 is represented by a handgun. The weapon 101 has transponder tag 103 permanently mounted under the grip. The grip is typically a shock absorbing material that is neutral to radio waves. Once the tag 103 is mounted under the grip non-removable screws are installed to prohibit removal of the tag 103. If the weapon 101 is such as a rifle the tag 103 is mounted under the stock pad that is comprised of similar material to the weapon 101 grip. Typically the tag 103 is passive and as such has no battery and therefore requires no maintenance or owner attention. A reader 105 is shown with an antenna 107 to interrogate a transponder such as tag 103. The reader 105 when commanded to interrogate a transponder will radiate radio frequency energy in the appropriate frequency band to achieve sympathetic power induction in the transponder tag 103 causing a query for identification information. The tag 103 when receiving energy in the appropriate band with a recognizable query will store energy, power up receiver, transmitter, memory, and controller in the tag 103 and radiate the stored identification information. The reader will receive the identification information from the tag 103 and pass on the information that a weapon has been detected to such as a machine 109. The machine 109 is typically a computer or processor with an interface port for the reader 105 and a display that a weapon has been detected for operators to monitor. The machine 109 can be as simple as a smart phone with a plug in reader 105 or such as a laptop with many functions. The machine 109 will also have an antenna 111 or cable or fiber optics to facilitate connection to local area networks (LAN) 113. The LAN 113 has an antenna 115 to receive local signals from such as machine 109. Connecting the machine 109 through the antenna 111 to the LAN 113 facilitates connection to local database 119. The LAN 113 also has an antenna 117 or cable to connect the LAN 113 to wide area networks and such as what is referred to as the “Cloud” for data access and storage. While the antenna 117 is shown as the external wide area network connection any suitable hard line, fiber optics, or similar connection is appropriate to connect the invisible concealed weapon identification system to external data exchanges.

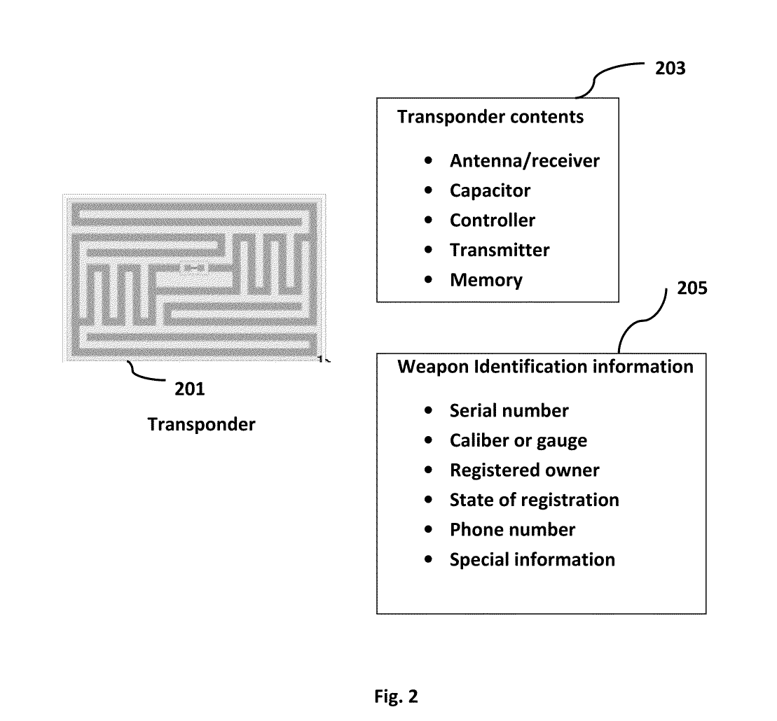

FIG. 2 shows a typical physical embodiment of typical Radio Frequency Identification (RFID) Tag. A transponder 201 is shown to depict the typical physical layout of an RFID tag. A transponder contents 203 column lists the contents of the typical transponder 201 these contents include; antenna/receiver, capacitor, controller, transmitter, and non-volatile memory. A weapon identification information 205 typically contained in the transponder 201 column lists the information typically stored in a transponder 203 memory this information includes; weapon serial number, caliber or gauge of the weapon, registered owner of the weapon, state the weapon is registered in, phone number of the owner, and any special information about the weapon or weapon's history.

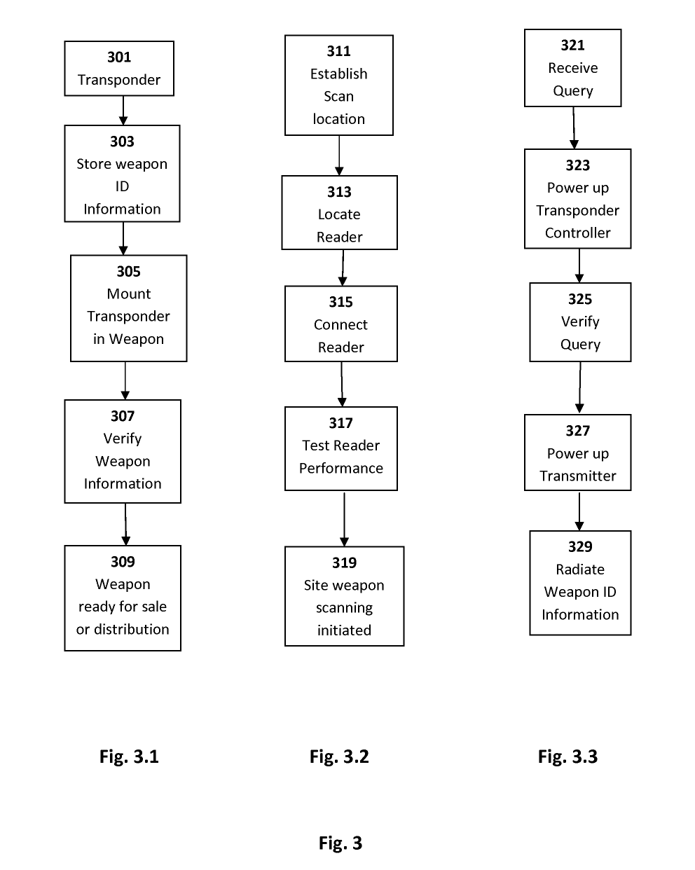

FIG. 3 displays the system operational flow of a typical invisible concealed weapon identification system.

FIG. 3.1 discloses the setup sequence of a weapon with a typical identification Tag.

When a typical invisible concealed weapon identification system is being set up an appropriate transponder 301 is selected. The transponder is placed on a transponder tag writer and the typical weapon identification information is store weapon ID information 303 is permanently stored in the transponder. The transponder is removed from the tag writer and mounted in the handle or base of the weapon under the grip or stock pad in mount transponder in weapon 305. A transponder tag reader is used to verify the write operation in verify weapon information 307 where the reader will display the information read from the tag and verified to be the same as written. With the transponder tag selected, mounted, information stored and verified the weapon is ready for sale or distribution 309. If the weapon was already owned and this is part of registration the weapon is returned to the owner.

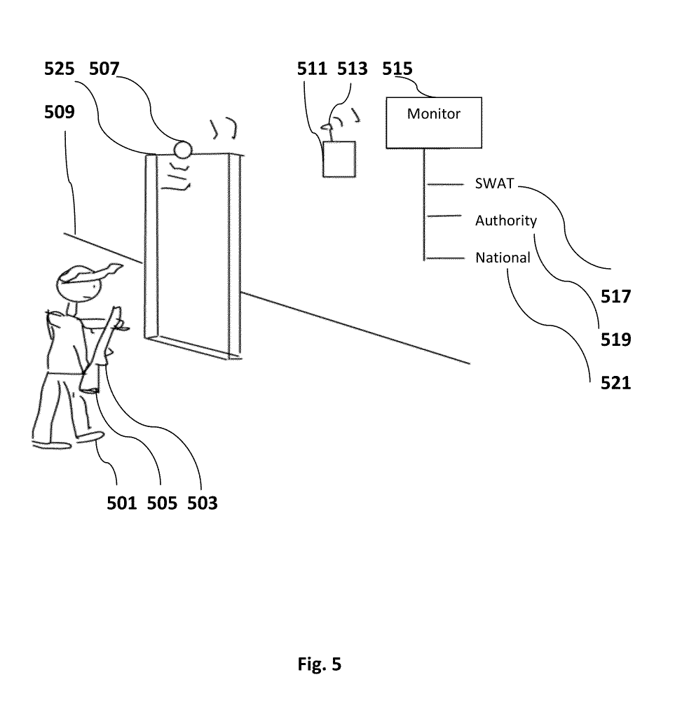

FIG. 3.2 discloses the typical setup of a transponder tag reader. A typical transponder tag reader location will be dependent on the specific area to be protected by the invisible concealed weapon identification system. For example a building or meeting place as shown in FIG. 5 will scan at a perimeter penetration and where multiple penetrations are available each will have a scanner. Returning to FIG. 3.2 a reader set up will first establish a scan location 311 this selection should be based on physical requirements and type of crowd flow for the location. Next locate the reader 313 is accomplished where the actual reader can be hidden or visible depending on the protection scenario. Next connect the reader 315 to the machine, computer, or interface to the local area network.

Next test reader performance 317 it is vital that the system operation is verified end to end to avoid unseen gaps or other problems. Site weapon scanning initiated 319 will bring the scanning of transponder tagged weapons on line for detecting weapons nearby.

FIG. 3.3 discloses the typical operation of a tag when being read by a tag reader. With the transponder tag setup in FIG. 3.1 and the scanner scenario configured in FIG. 3.2 the invisible concealed weapon identification system will operate as follows. A receive query 321 starts a transponder tag into responsive action. The energy from the reader charges up the transponder capacitor, this charge acts like a battery and powers up the transponder receiver, memory, and controller 323, the controller verifies the reader query 325 and when verified causes the power up transmitter 327 with memory id information to be radiated 329 out the antenna for the querying reader to collect the transponder tag weapon information.

There are various standards and frequencies to choose from when implementing an invisible concealed weapon identification system a typical sample list of standards and frequencies follows.
ISO 14223—Radiofrequency identification of animals.
ISO/IEC 14443—HF (13.56 MHZ) typically used in passports.
ISO/IEC 15693—HF (13.56 MHZ) typically used in smart payment and credit cards.
ISO/IEC 18000—Radio frequency identification for item management
   Part 1: Reference architecture and definition of parameters to be standardized
   Part 2: Parameters for air interface communications below 135 kHz
   Part 3: Parameters for air interface communications at 13.56 MHz
   Part 4: Parameters for air interface communications at 2.45 GHz
   Part 6: Parameters for air interface communications at 860-960 MHz
   Part 7: Parameters for active air interface communications at 433 MHz
ISO/IEC—18092 Information technology—Telecommunication and information exchange between systems—near field communication, Protocol 1.
ISO 18158—Industry standard for electronic seals (433 MHZ and 2.4 GHZ).
ISO/IEC—21481—Information technology—telecommunications and information exchange, Protocol 2.

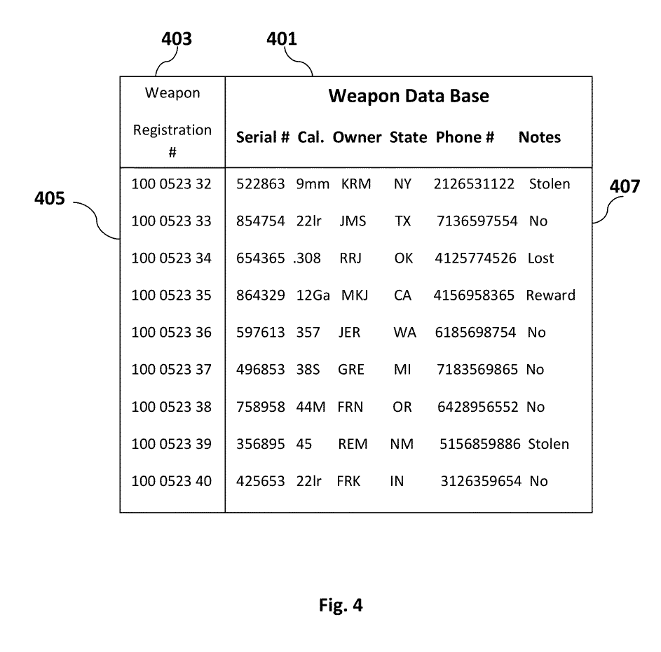

FIG. 4 shows a typical invisible concealed weapon identification system data base. Many variations may be implemented and the FIG. 4 is merely a typical starting point. A weapon data base 401 is shown with columns for serial # of a weapon, caliber or gauge of a weapon, owner of a weapon, state of residency of a weapon, phone number of an owner of a weapon, and any specific notes on the weapon or the owner. A column of weapon registration numbers 403 is shown with typical registration numbers 405 coinciding with weapon serial numbers. A data base of weapon sample information 407 is shown for a typical data base representation (not real data).

FIG. 5 shows a typical operating scenario for an invisible concealed weapon identification system. In the depicted scenario an individual 501 with a rifle 503 containing a transponder tag 505 mounted under the stock pad is shown attempting to enter a compound with a perimeter fence 509 an entrance gate 525 and a transponder reader 507. The reader and interface computer 507 will query the approaching individual 501 and receive weapon information from the tag 505 in the rifle 503 the reader and interface computer 507 will communicate this information over local area network to base station 511 through antenna 513 the information is typically made available to the security monitor station 515 or SWAT 517 or other rapid reaction team, appropriate authorities 519. These data can also be made available to the entire national data base 521 when one is available through various interconnection ways including “cloud” technology.

### Operation

When operating an invisible concealed weapon identification system the first step is to follow the flow instructions depicted in FIG. 3. Specifically, the appropriate transponder is installed on all weapons and the appropriate identification information is stored in a State or National Weapon Data Base. Transponder readers and network interfaces are installed on all critical meeting, gathering places, and school or similar public places where a shooter is a hazard. The invisible concealed weapon identification system is powered up and provides an early warning of approaching danger. When a transponder tag is installed one way screws are discussed in FIG. 1 it is envisioned that these screws would be limited distribution and identifiable if tampered with for reasons such as removal of the transponder tag.

### DESCRIPTION OF THE PREFERRED EMBODIMENT(S)

In the preferred embodiment of the invisible concealed weapon identification system the transponder tag of FIG. 2 is mounted in the handle or stock of a weapon with grip or pad as shown in FIG. 1 comprised of a non-radio communication interfering material as used in most weapons already. A reader interface to a machine or computer or similar processor ties the reader into a local area network and authorities can monitor gates as shown in FIG. 5 and penetration from anywhere in the area or remotely for approaching weapons.

1. A concealed weapon identification system with a plurality of modules comprised of;
a permanent non-visible advanced technology resonant frequency sympathetic powered identification transponder mounted internal to a weapon,
the transponder includes an antenna for conducting two-way communication with a reader, a capacitor for power, a receiver, a transmitter, a controller, and a non-volatile memory retaining the weapon identification data and operating sequence,
the reader includes an antenna capable of gathering data from advanced technology identification device transponder through emitting resonant frequency power to sympathetically excite the transponder capacitor of the transponder mounted in the weapon, causing the transponder controller to emit the weapon identification data, reading these weapon identification data emitted from the transponder and storing these data,
a machine interfacing to the reader capable of reading the weapon identification data gathered from the transponder, emitting an alert displaying and storing these data in a data base,
a connection from the machine to a local area computer network connecting the machine interface to a data base,
a connection from the local area network to a wide area computer network connecting the data base to external data base(s) and appropriate authorities, and
early detection of concealed weapons is provided through systems equipped with the transponder when entering an area with the non-visible transponder being sympathetically excited by the reader energy, the transponder emitting weapon identification information through radiation, the transponder response information received by the reader, the information deciphered by the reader, the reader sounding an alert when a weapon is detected, and recording the weapon identification alert with time, location, and any additional information while reporting these data to a network or series of networks possibly including authorities.

2. The concealed weapon identification system of claim 1 wherein, the weapon transponder tag has no battery and therefore requires no maintenance.

3. The concealed weapon identification system of claim 1 wherein, the mounting of the transponder tag is not visible from the external view of the weapon.

4. The concealed weapon identification system of claim 1 wherein, reader to transponder and reader operating frequencies are selectable for a specific application.

5. The concealed weapon identification system of claim 1 wherein, the process for scanning id data for is non-visible to the weapon carrier.

6. The concealed weapon identification system of claim 1 wherein, the transponder is mounted under a weapon handle grip for a handgun, comprised of shock absorbing material non-interfering to signals in the electromagnetic radio band,

7. The concealed weapon identification system of claim 1 wherein, the transponder is mounted under a weapon stock pad for a rifle, comprised of shock absorbing material non-interfering to signals in the electromagnetic radio band.

8. The concealed weapon identification system of claim 1 wherein, anti-removal technology for inhibiting removal of transponder from weapon is provided by non-removable screws.

9. The concealed weapon identification system of claim 1 wherein, limiting availability of non-removable screws to certified transponder installers identifies screws that have been tampered with.

10. The concealed weapon identification system of claim 1 wherein, the transponder is installed in the weapon when the weapon is produced.

11. The concealed weapon identification system of claim 1 wherein, the transponder is installed in an existing weapon.

12. A method of implementing a concealed weapon identification system with a plurality of modules consisting of:
installing a permanent non-visible advanced technology resonant frequency sympathetic powered identification transponder mounted internal to a weapon, including in the transponder an antenna for conducting two-way communication with a reader, a capacitor for power, a receiver, a transmitter, a controller, and a non-volatile memory retaining the weapon identification data and operating sequence, including in the reader an antenna capable of gathering data from advanced technology identification device transponder through emitting resonant frequency power to sympathetically excite the transponder capacitor of the transponder mounted in the weapon, causing the transponder controller to emit the weapon identification data, reading these weapon identification data emitted from the transponder and storing these data,
interfacing a machine to the reader capable of reading the weapon identification data gathered from the transponder, emitting an alert displaying and storing these data in a data base,
connecting the machine to a local area computer network connecting the machine interface to a data base,
connecting the local area network to a wide area computer network connecting the data base to external data base(s) and appropriate authorities, and
implementing early detection of concealed weapons equipped with the transponder when entering an area with the non-visible transponder being sympathetically excited by the reader energy, the transponder emitting weapon identification information through radiation, the transponder response information received by the reader, the information deciphered by the reader, the reader sounding an alert when a weapon is detected, and recording the weapon identification alert with time, location, and any additional information while reporting these data to a network or series of networks possibly including authorities.

13. The method of implementing a concealed weapon identification system of claim 12 wherein, the weapon transponder tag has no battery and therefore requires no maintenance.

14. The method of implementing a concealed weapon identification system of claim 12 wherein, the mounting of the transponder tag is not visible from the external view of the weapon.

15. The method of implementing a concealed weapon identification system of claim 12 wherein, reader to transponder and reader operating frequencies are selectable for a specific application.

16. The method of implementing a concealed weapon identification system of claim 12 wherein, the process for scanning id data for is non-visible to the weapon carrier.

17. The method of implementing a concealed weapon identification system of claim 12 wherein, the transponder is mounted under a weapon handle grip for a handgun, comprised of shock absorbing material non-interfering to signals in the electromagnetic radio band,

18. The method of implementing a concealed weapon identification system of claim 12 wherein, the transponder is mounted under a weapon stock pad for a rifle, comprised of shock absorbing material non-interfering to signals in the electromagnetic radio band.

19. The method of implementing a concealed weapon identification system of claim 12 wherein, anti-removal technology for inhibiting removal of transponder from weapon is provided by non-removable screws.

20. The method of implementing a concealed weapon identification system of claim 12 wherein, limiting availability of non-removable screws to certified transponder installers identifies screws that have been tampered with.

21. The method of implementing a concealed weapon identification system of claim 12 wherein, the transponder is installed in the weapon when the weapon is produced.

22. The method of implementing a concealed weapon identification system of claim 12 wherein, the transponder is installed in an existing weapon.
